(19) United States
(12) Patent Application Publication
(10) Pub. No.: US 2020/0398625 A1
(43) Pub. Date: Dec. 24, 2020

(54) SUSPENSION SYSTEM FOR ALL-TERRAIN VEHICLE AND ALL-TERRAIN VEHICLE

(71) Applicant: SEGWAY TECHNOLOGY CO., LTD., Changzhou (CN)

(72) Inventors: Wei Han, Beijing (CN); Yongjun Liu, Beijing (CN)

(21) Appl. No.: 16/858,921

(22) Filed: Apr. 27, 2020

Related U.S. Application Data
(63) Continuation of application No. PCT/CN2019/125094, filed on Dec. 13, 2019.

(30) Foreign Application Priority Data
Jun. 21, 2019 (CN) 201920948732.1

(51) Int. Cl. B60G 3/20; B60G 7/00; B60G 7/02; B60G 13/00

(52) U.S. Cl. CPC B60G 3/202; B60G 7/008; B60G 7/02; B60G 13/003; B60G 13/005; F16D 3/16; B60G 2300/07; B60G 2200/182; B60G 2204/143; B60G 2204/148; B60G 2300/124

(57) ABSTRACT

The present disclosure relates to a suspension system for an all-terrain vehicle. The suspension system includes a mount for a rear wheel shaft having a front portion and a rear portion; a toe controlling rod having an outer end coupled to the front portion and an inner end opposite the outer end; and a brake coupled to the rear portion. The present disclosure also relates to another suspension system for an all-terrain vehicle and an all-terrain vehicle.

### CROSS-REFERENCE TO RELATED APPLICATION

This application is a continuation of PCT Application No. PCT/CN2019/125094, filed on Dec. 13, 2019, which claims priority to and benefits of Chinese Patent Application No. 201920948732.1, filed on Jun. 21, 2019, the entire content of all of which is incorporated herein by reference.

### FIELD

The present disclosure relates to a field of vehicle manufacturing, and more particularly, to an all-terrain vehicle.

### BACKGROUND

A suspension system of a vehicle refers to an entire support system including springs and shock absorbers between a vehicle body and tires. The suspension system integrates multiple forces, which can isolate unevenness of road surfaces, thereby making driving more comfortable, and keeps tires in contact with an uneven road surface when the vehicle runs along the road surface. The suspension system determines the stability, comfort and safety of the vehicle and is one of the most critical components in the vehicle.

### SUMMARY

Embodiments of a first aspect of the present disclosure provide a suspension system for an all-terrain vehicle. The suspension system includes a mount for a rear wheel shaft having a front portion and a rear portion; a toe controlling rod having an outer end coupled to the front portion and an inner end opposite the outer end; and a brake coupled to the rear portion.

Embodiments of a second aspect of the present disclosure provide another suspension system for an all-terrain vehicle. The suspension system includes a mount for a rear wheel shaft having a front portion and a rear portion; a toe controlling rod having an outer end coupled to a front portion and an inner end opposite the outer end and configured to be coupled to a frame of the all-terrain vehicle; and a rear trailing arm having a front end configured to be coupled to the frame of the all-terrain vehicle and a rear end coupled to the mount for the rear wheel shaft.

Embodiments of a third aspect of the present disclosure provide an all-terrain vehicle. The all-terrain vehicle includes a frame; a mount for a rear wheel shaft; a toe controlling rod having an outer end coupled to a front portion of the mount for the rear wheel shaft and an inner end coupled to the frame; and a brake disposed at a rear portion of the mount for the rear wheel shaft.

Additional aspects and advantages of the present disclosure will be given in part in the following descriptions, become apparent in part from the following descriptions, or be learned from the practice of the present disclosure.

### BRIEF DESCRIPTION OF THE DRAWINGS

These and other aspects and advantages of the present disclosure will become apparent and more readily appreciated from the following descriptions about embodiments with reference to the drawings, in which:

FIG. 1 illustrates a perspective view of an all-terrain vehicle according to an embodiment of the present disclosure.

FIG. 2 illustrates a front view of the all-terrain vehicle in FIG. 1.

FIG. 3 illustrates a partial schematic view of the all-terrain vehicle in FIG. 1.

FIG. 4 illustrates a partial exploded view of the all-terrain vehicle of FIG. 1 at a mount for a rear wheel shaft.

FIG. 5 illustrates a perspective view of a complete all-terrain vehicle.

### DETAILED DESCRIPTION

Embodiments of the present disclosure will be described in detail below, and the embodiments described with reference to the drawings are exemplary. The embodiments of the present disclosure are described below.

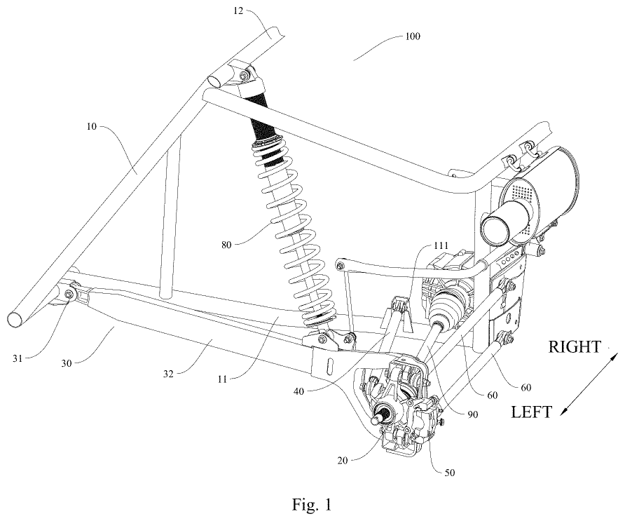

An all-terrain vehicle 1000 according to embodiments of the present disclosure is described below with reference to FIGS. 1-5. The all-terrain vehicle 1000 may have a suspension system 100.

As shown in FIG. 1, the all-terrain vehicle 1000 according to the embodiments of the present disclosure includes: a frame 10, a mount 20 for a rear wheel shaft, a rear trailing arm 30, a toe controlling rod 40, and a brake 50. The frame 10 determines the shape of the vehicle and the size of the internal space of the vehicle frame 10, and most components are arranged in the frame 10.

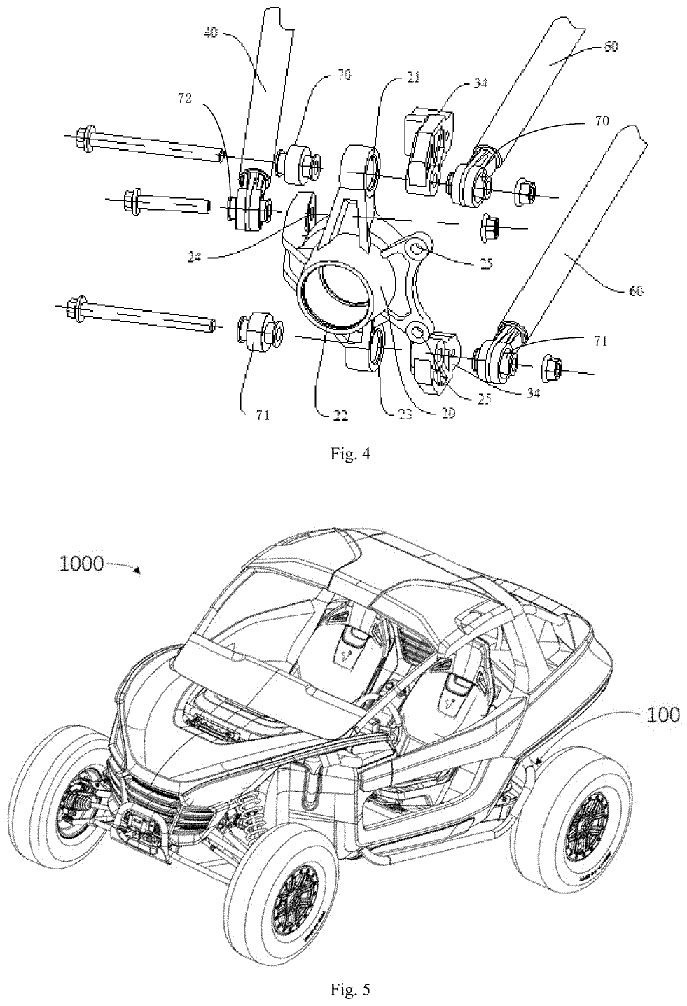

As shown in FIG. 4, the mount 20 for the rear wheel shaft is provided with a plurality of apertures in a surface thereof. An aperture of a large diameter is provided in a middle position of a surface of an obverse side of the mount for the rear wheel shaft, and this aperture in the middle position can be used to mount a hub bearing to support the rear wheel shaft. The mount 20 for the rear wheel shaft is provided with a first strip-shaped member extending upwards at an upper portion of the mount 20 for the rear wheel shaft, and a second strip-shaped member extending downwards at a lower portion of the mount for the rear wheel shaft, and a portion of the first strip-shaped member at or near its free end and a portion of the second strip-shaped member at or near its free end are provided with longitudinal through holes, which can be used for connection with other components. A front portion of the mount 20 for the rear wheel shaft has a rectangular structure extending to a reverse side, and a surface of the rectangular structure is also provided with a longitudinal through hole which can be used for connection with other components.

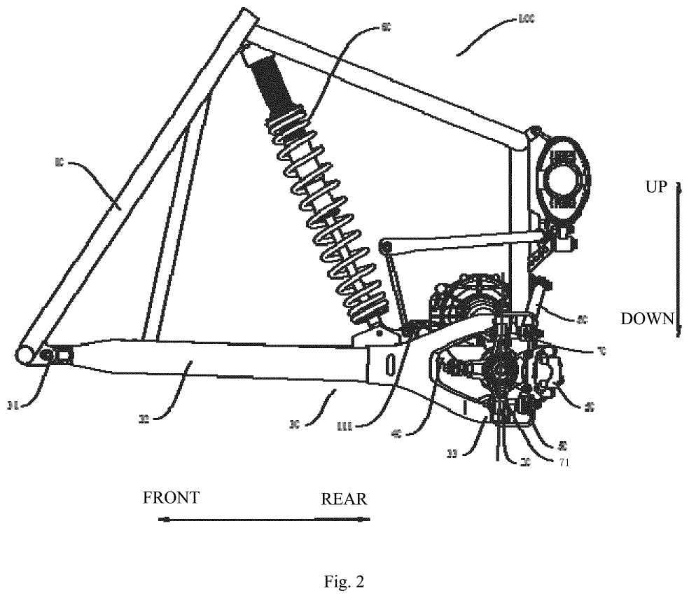

As shown in FIG. 1 and FIG. 2, the rear trailing arm 30 has an elongated batten shape with a large end and a small end. A front end (the end having small area) of the rear trailing arm 30 is coupled to the frame 10 through fasteners, and a rear end (the end having large area) of the rear trailing arm 30 is coupled to the mount 20 for the rear wheel shaft through fasteners. The rear trailing arm 30 is arranged along a longitudinal direction. The longitudinal direction is a front-rear direction shown in FIG. 2.

As shown in FIG. 1, the toe controlling rod 40 exhibits an elongated bar shape. An outer end of the toe controlling rod 40 is coupled to a front portion of the mount 20 for the rear wheel shaft. The all-terrain vehicle also includes a rear axle, and the rear axle includes a half shaft 90. The half shaft 90 has a first end coupled to the mount 20 for the rear wheel shaft and a second end coupled to a decelerator. The outer end of the toe controlling rod 40 is located in front of the half shaft 90. The toe controlling rod 40 arranged in this way can make use of the front space of the mount 20 for the rear wheel shaft reasonably and will not be interfered during movement. Moreover, an inner end of the toe controlling rod 40 is coupled to the frame 10, and the toe controlling rod 40 can control toe angles of rear wheels. Specifically, as shown in FIG. 1, a left end of the toe controlling rod 40 is the outer end, while a right end thereof is the inner end. The brake 50 is disposed at a rear portion of the mount 20 for the rear wheel shaft and acts as a braking device of the all-terrain vehicle 1000. The brake 50 can generate a force that hinders the movement of the all-terrain vehicle 1000. In this way, the toe controlling rod 40 is arranged at the front portion of the mount 20 for the rear wheel shaft, and the brake 50 is arranged at the rear portion of the mount 20 for the rear wheel shaft. The toe controlling rod 40 does not interfere with the brake 50, and hence avoids affecting the liquid filling and air exhaust of the brake 50. The all-terrain vehicle 1000 can has a reasonable arrangement at the mount 20 for the rear wheel shaft, and the normal operation of various components can be ensured. The toe controlling rod 40 can adjust positioning parameters of the mount 20 for the rear wheel shaft effectively, such that the mount 20 for the rear wheel shaft can obtain a larger travel and the motion trajectory of the mount 20 for the rear wheel shaft can be controlled effectively. In addition, such an arrangement can occupy less rear space of the all-terrain vehicle 1000 and have a high space utilization rate.

As a result, the arrangement can not only occupy less rear space of the all-terrain vehicle 1000 and make the overall layout of the vehicle more reasonable, but also ensure the normal operation of other components, which is beneficial to the liquid filling and the air exhaust of the brake 50 and further facilitates the maintenance of the brake 50.

According to a specific embodiment of the present disclosure, as shown in FIG. 2, the rear trailing arm 30 includes a front mounting head 31, a main body 32, and two rear mounting heads 33. The small area end is configured as the front mounting head 31, the large area end is configured as the rear mounting heads 33, and the elongated batten-shaped structure is configured as the main body 32. The main body 32 has a front end coupled to the front mounting head 31, and a rear end coupled to the two rear mounting heads 33. The two rear mounting heads 33 are spaced in an up-down direction (i.e. a vertical direction). The front mounting head 31 of the rear trailing arm 30 is coupled to the frame 10, and the two rear mounting heads 33 of the rear trailing arm 30 are coupled to an upper portion and a lower portion of the mount 20 for the rear wheel shaft respectively. The rear trailing arm 30 arranged in this way can avoid the outer end of the toe controlling rod 40 effectively and facilitate the assembly of the toe controlling rod 40 at the mount 20 for the rear wheel shaft.

According to another specific embodiment of the present disclosure, as shown in FIG. 1 and FIG. 4, the rear mounting head 33 includes a mounting block 34, and the mounting block 34 is welded or fixed to the rear mounting head 33 by a screw or bolt connection, and each of the rear mounting head 33 located above (as an example of a first rear mounting head) and the rear mounting head 33 located below (as an example of a second rear mounting head) is provided with a mounting block 34. The mounting block 34 is provided with a perforation. The all-terrain vehicle 1000 also includes two tie rods 60 spaced in the up-down direction, and the two tie rods 60 can move up and down relative to the mount 20 for the rear wheel shaft. The length of the tie rod 60 located above is greater than the length of the tie rod 60 located below. By means of the two tie rods 60 arranged in this way, a camber angle when the mount 20 for the rear wheel shaft bounces up and down and a displacement when the mount 20 for the rear wheel shaft slips laterally change little.

The tie rod 60 located above has a connection portion at an outer end of the tie rod 60 located above, the tie rod 60 located below has a connection portion at an outer end of the tie rod 60 located below, and the connection portion of the tie rod 60 located above and the connection portion of the tie rod 60 located below are both provided with through holes. The connection portion of the tie rod 60 located above is coaxially mounted with the mounting block 34 of the rear mounting head 33 located above at the rear end of the rear trailing arm 30 and coaxially mounted with the upper portion of the mount 20 for the rear wheel shaft by using fasteners. In other words, an axis of the through hole in the connection portion of the tie rod 60 located above, an axis of the perforation in the mounting block 34 of the rear mounting head 33 located above at the rear end of the rear trailing arm 30, and an axis of an through hole in the upper portion of the mount 20 for the rear wheel shaft coincide. The connection portion of the tie rod 60 located below is coaxially mounted with the mounting block 34 of the rear mounting head 33 located below at the rear end of the rear trailing arm 30 and coaxially mounted with the lower portion of the mount 20 for the rear wheel shaft by using fasteners. In other words, an axis of the through hole in the connection portion of the tie rod 60 located below, an axis of the perforation in the mounting block 34 of the rear mounting head 33 located below at the rear end of the rear trailing arm 30, and an axis of an through hole in the lower portion of the mount 20 for the rear wheel shaft coincide. An inner end of the tie rod 60 located above and an inner end of the tie rod 60 located below are both coupled to the frame 10. The tie rods 60 thus arranged are convenient to mount and have a more reasonable layout, and their coaxial mounting with the rear trailing arm 30 and the mount 20 for the rear wheel shaft can guarantee the coaxiality.

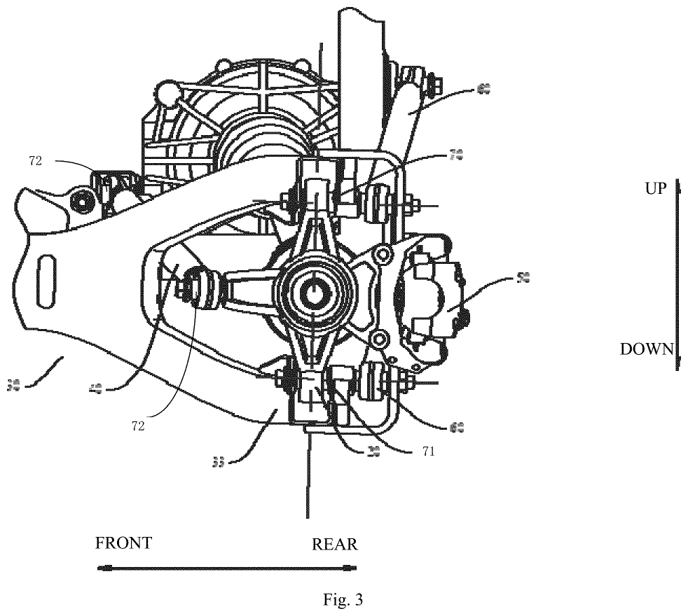

Optionally, as shown in FIG. 3 and FIG. 4, each of the connection portion of the tie rod 60 located above and the upper portion of the mount 20 for the rear wheel shaft is provided with a first joint bearing 70 configured to allow the fastener to pass through. The first joint bearings 70 are disposed in the through hole at the connection portion of the tie rod 60 located above and in the through hole at the upper portion of the mount 20 for the rear wheel shaft. By using fasteners, for example by using bolts and nuts (certainly, other fasteners can also be used), the connection portion of the tie rod 60 located above is coaxially mounted with the mounting head located above at the rear end of the rear trailing arm 30 and mounted with the upper portion of the mount 20 for the rear wheel shaft. Each of the connection portion of the tie rod 60 located below and the lower portion of the mount 20 for the rear wheel shaft is provided with a second joint bearing 71 configured to allow the fastener to pass through. The second joint bearings 71 are disposed in the through hole at the connection portion of the tie rod 60 located below and in the through hole at the lower portion of the mount 20 for the rear wheel shaft. By using fasteners, the connection portion of the tie rod 60 located below is coaxially mounted with the mounting head located below at the rear end of the rear trailing arm 30 and mounted with the lower portion of the mount 20 for the rear wheel shaft. By using the second joint bearings 71, the friction coefficient can be reduced, and the rotation accuracy can be ensured.

The half shaft 90 is coupled to the mount 20 for the rear wheel shaft through an outer ball cage. The center of the outer ball cage of the half shaft 90 is located on a line connecting centers of the first joint bearing 70 in the upper portion of the mount 20 for the rear wheel shaft and the second joint bearing 71 in the lower portion of the mount 20 for the rear wheel shaft, that is, the center of the outer ball cage of the half shaft 90 and the centers of the first joint bearing 70 and the second joint bearing 71 are located on the same connection line. The connection line defines a virtual kingpin axis extending vertically, i.e., a rotation axis of the mount 20 for the rear wheel shaft. With such an arrangement, the rotation stability of the mount 20 for the rear wheel shaft can be ensured, and the inclination angles of the rear wheels can be effectively restricted.

Specifically, as shown in FIG. 1, the frame 10 includes an oblique longitudinal rail 11, the oblique longitudinal rail 11 is located at an inner side of the rear trailing arm 30, and the inner end of the toe controlling rod 40 is coupled to the oblique longitudinal rail 11. The toe controlling rod 40 thus arranged is simple to mount and extends substantially in a transverse direction (i.e. a left-right direction), which can facilitate its control over the toe angles of the rear wheels.

Further, as shown in FIG. 1, the outer end and the inner end of the toe controlling rod 40 are provided with third joint bearings 72 configured to allow the fasteners to pass through. The oblique longitudinal rail 11 is provided with a mounting bracket 111. At the inner end of the toe controlling rod 40, the third joint bearing 72 is mounted on the mounting bracket 111 via the fastener. By using the third joint bearing 72, the friction coefficient can be reduced and the rotation accuracy can be ensured. Since the oblique longitudinal rail 11 is provided with the mounting bracket 111, the toe controlling rod 40 can be fixed conveniently, and the stability of connection between the toe controlling rod 40 and the oblique longitudinal rail 11 can be enhanced.

According to a specific embodiment of the present disclosure, as shown in FIGS. 1 and 2, the all-terrain vehicle 1000 further includes a shock absorber 80, and the frame 10 includes an upper transverse rail 12. The shock absorber 80 has a front upper end coupled to the upper transverse rail 12 via a fastener and a rear lower end coupled to the rear trailing arm 30 via a fastener. The shock absorber 80 has a cylindrical structure, and an elastic element encloses the periphery of the shock absorber to fix the shock absorber 80 on the upper transverse rail 12 and the rear trailing arm 30. On the one hand, unoccupied space between the upper transverse rail 12 and the rear trailing arm 30 is fully utilized to make the space layout of the whole vehicle more reasonable; on the other hand, the shock absorption effect on the vehicle body is enhanced.

According to another specific embodiment of the present disclosure, as shown in FIG. 4, the mount 20 for the rear wheel shaft is an integrally formed piece and is provided with an upper mounting aperture 21, a middle support aperture 22, a lower mounting aperture 23, a front mounting aperture 24 and a rear mounting aperture 25. The middle support aperture 22 is located in the obverse side of the mount 20 for the rear wheel shaft; the upper mounting aperture 21 and the lower mounting aperture 23 are located at the upper portion and the lower portion of the mount 20 for the rear wheel shaft; the front mounting aperture 24 is located at the front portion of the mount 20 for the rear wheel shaft, and the rear mounting aperture 25 is located at the rear portion of the mount 20 for the rear wheel shaft. The middle support aperture 22 is used to mount the hub bearing to support the wheel shaft; the upper mounting aperture 21 is used to mount the first joint bearing 70, and the lower mounting aperture 23 is used to mount the second joint bearing 71; and the front mounting aperture 24 and the rear mounting aperture 25 are used to allow the fasteners to pass through. The mount 20 for the rear wheel shaft as an integrally formed piece can reduce the manufacturing complexity, time and cost on the one hand, and can improve the strength and ensure the reliability of the mount 20 for the rear wheel shaft on the other hand.

In the description of the present disclosure, it is to be understood that terms such as “central,” “longitudinal,” “transverse,” “length,” “width,” “thickness,” “upper,” “lower,” “front,” “rear,” “left,” “right,” “vertical,” “horizontal,” “top,” “bottom,” “inner,” and “outer” should be construed to refer to the orientation or position as then described or as shown in the drawings under discussion. These relative terms are for convenience and simplicity of description, and do not indicate or imply that the device or element referred to must have a particular orientation, or be constructed and operated in a particular orientation. Thus, these terms should not be constructed to limit the present disclosure.

In the description of the present disclosure, the term “a plurality of” means two or more than two, unless specified otherwise. In the description of the present disclosure, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature.

Reference throughout this specification to “an embodiment,” “some embodiments,” “an exemplary embodiment”, “an example,” “a specific example,” or “some examples,” means that a particular feature, structure, material, or characteristic described in connection with the embodiment or example is included in at least one embodiment or example of the present disclosure. Thus, the above terms throughout this specification are not necessarily referring to the same embodiment or example of the present disclosure.

Although embodiments of the present disclosure have been shown and described, it would be appreciated by those skilled in the art that various changes, modifications, alternatives and variations can be made in the embodiments without departing from principles and purposes of the present disclosure. The scope of the present disclosure is defined by the claims and their equivalents.

What is claimed is:

1. A suspension system for an all-terrain vehicle, comprising:
a mount for a rear wheel shaft, having a front portion and a rear portion;
a toe controlling rod having an outer end coupled to the front portion and an inner end opposite the outer end; and
a brake coupled to the rear portion.

2. The suspension system according to claim 1, further comprising: a rear trailing arm extending along a longitudinal direction and coupled to the mount for the rear wheel shaft.

3. The suspension system according to claim 2, wherein the rear trailing arm comprises:
a front mounting head,
a first rear mounting head and a second rear mounting head spaced in a vertical direction perpendicular to the longitudinal direction, the first rear mounting head being located above the second rear mounting head, the first rear mounting head being coupled to an upper portion of the mount for the rear wheel shaft, and the second rear mounting head being coupled to a lower portion of the mount for the rear wheel shaft, and
a main body having a front end coupled to the front mounting head and a rear end coupled to the first rear mounting head and the second mounting head.

4. The suspension system according to claim 3, further comprising a first tie rod and a second tie rod spaced in the vertical direction, the first tie rod being located above the second tie rod; the first tie rod having a connection portion at an outer end thereof, the second tie rod having a connection portion at an outer end thereof;
the connection portion of the first tie rod, a mounting block of the first rear mounting head, and the upper portion of the mount for the rear wheel shaft being coaxially mounted; the connection portion of the second tie rod, a mounting block of the second rear mounting head, and the lower portion of the mount for the rear wheel shaft being coaxially mounted.

5. A suspension system for an all-terrain vehicle, comprising:
a mount for a rear wheel shaft having a front portion and a rear portion;
a toe controlling rod having an outer end coupled to a front portion and an inner end opposite the outer end and configured to be coupled to a frame of the all-terrain vehicle; and
a rear trailing arm having a front end configured to be coupled to the frame of the all-terrain vehicle and a rear end coupled to the mount for the rear wheel shaft.

6. The suspension system according to claim 5, wherein the front portion has a rectangular structure extending inwards along a transverse direction, the rectangular structure is provided with a front mounting aperture, and the outer end of the toe controlling rod is mounted to the front mounting aperture.

7. The suspension system according to claim 6, wherein the mount for the rear wheel shaft is provided with a first strip-shaped member extending upwards at an upper portion of the mount for the rear wheel shaft and defining an upper mounting aperture, and a second strip-shaped member extending downwards at a lower portion of the mount for the rear wheel shaft and defining a lower mounting aperture;
wherein the rear trailing arm comprises a first rear mounting head and a second rear mounting head spaced in a vertical direction perpendicular to the transverse direction, the first rear mounting head is located above the second rear mounting head, the first rear mounting head is mounted to the upper mounting aperture, and the second rear mounting head is mounted to the lower mounting aperture.

8. The suspension system according to claim 7, further comprises a first tie rod and a second tie rod spaced in the vertical direction, wherein the first tie rod is located above the second tie rod, the first tie rod has a connection portion at an outer end thereof, the second tie rod has a connection portion at an outer end thereof; the first rear mounting head and the connection portion of the first tie rod are coaxially mounted to the upper mounting aperture; and the second rear mounting head and the connection portion of the second tie rod are coaxially mounted to the lower mounting aperture.

9. The suspension system according to claim 7, wherein the mount for the rear wheel shaft defines a rear mounting aperture at a rear portion thereof, and a brake is mounted to the rear mounting aperture.

10. An all-terrain vehicle, comprising:
a frame;
a mount for a rear wheel shaft;
a toe controlling rod having an outer end coupled to a front portion of the mount for the rear wheel shaft and an inner end coupled to the frame; and
a brake disposed at a rear portion of the mount for the rear wheel shaft.

11. The all-terrain vehicle according to claim 10, further comprising: a rear trailing arm having a front end coupled to the frame and a rear end coupled to the mount for the rear wheel shaft, and disposed along a longitudinal direction;
wherein the rear trailing arm comprises: a front mounting head, a main body, and a first rear mounting head and a second rear mounting head; the main body has a front end coupled to the front mounting head and a rear end coupled to the first rear mounting head and the second mounting head; the first rear mounting head and the second rear mounting head are spaced in a vertical direction perpendicular to the longitudinal direction, and the first rear mounting head is located above the second rear mounting head; the front mounting head is coupled to the frame, and the first rear mounting head is coupled to an upper portion of the mount for the rear wheel shaft, and the second rear mounting head is coupled to a lower portion of the mount for the rear wheel shaft.

12. The all-terrain vehicle according to claim 11, wherein each rear mounting head comprises a mounting block;
the all-terrain vehicle further comprises a first tie rod and a second tie rod spaced in the vertical direction, the first tie rod is located above the second tie rod, the first tie rod has a connection portion at an outer end thereof, the second tie rod has a connection portion at an outer end thereof; the connection portion of the first tie rod, the mounting block of the first rear mounting head, and the upper portion of the mount for the rear wheel shaft are coaxially mounted; the connection portion of the second tie rod, the mounting block of the second rear mounting head, and the lower portion of the mount for the rear wheel shaft are coaxially mounted; an inner end of the first tie rod and an inner end of the second tie rod are coupled to the frame.

13. The all-terrain vehicle according to claim 12, wherein each of the connection portion of the first tie rod and the upper portion of the mount for the rear wheel shaft is provided with a first joint bearing; and each of the connection portion of the second tie rod and the lower portion of the mount for the rear wheel shaft is provided with a second joint bearing.

14. The all-terrain vehicle according to claim 13, further comprising a rear axle, wherein the rear axle comprises a half shaft having a first end coupled to the mount for the rear wheel shaft and a second end configured to be coupled to a decelerator, and the toe controlling rod is located in front of the half shaft.

15. The all-terrain vehicle according to claim 14, wherein the half shaft is coupled to the mount for the rear wheel shaft through an outer ball cage, and a center of the outer ball cage of the half shaft is located on a line connecting centers of the first joint bearing in the upper portion of the mount for the rear wheel shaft and the second joint bearing in the lower portion of the mount for the rear wheel shaft.

16. The all-terrain vehicle according to claim 10, further comprising:
a first tie rod having an outer end coupled to the mount for the rear wheel shaft and an inner end coupled to the frame;
a second tie rod having an outer end coupled to the mount for the rear wheel shaft and an inner end coupled to the frame, the first tie rod and the second tie rod being spaced in a vertical direction, and the first tie rod being located above the second tie rod; and
a half shaft having an outer end coupled to the mount for the rear wheel shaft and an inner end configured to be coupled to a decelerator,
wherein the toe controlling rod is located in front of the half shaft, and the first tie rod and the second tie rod are located behind the half shaft.

17. The all-terrain vehicle according to claim 11, wherein the frame comprises an oblique longitudinal rail located at an inner side of the rear trailing arm, and the inner end of the toe controlling rod is coupled to the oblique longitudinal rail.

18. The all-terrain vehicle according to claim 17, wherein each of the outer end and the inner end of the toe controlling rod is provided with a third joint bearing, the oblique longitudinal rail is provided with a mounting bracket, and at the inner end of the toe controlling rod, the third joint bearing is mounted on the mounting bracket via a fastener.

19. The all-terrain vehicle according to claim 11, further comprising a shock absorber, wherein the frame comprises an upper transverse rail, and the shock absorber has a front upper end coupled to the upper transverse rail and a rear lower end coupled to the rear trailing arm.

20. The all-terrain vehicle according to claim 10, wherein the mount for the rear wheel shaft is an integrally formed piece and is provided with an upper mounting aperture, a middle support aperture, a lower mounting aperture, a front mounting aperture, and a rear mounting aperture; the middle support aperture is configured to support the rear wheel shaft; a first joint bearing is mounted to the upper mounting aperture, and a second joint bearing is mounted to the lower mounting aperture.
